(19) United States
(12) Patent Application Publication
(10) Pub. No.: US 2011/0063583 A1
(43) Pub. Date: Mar. 17, 2011

(54) ILLUMINATION OPTICAL SYSTEM AND PROJECTION DISPLAY APPARATUS

(76) Inventor: Hiroyuki Saitou, Tokyo (JP)

(21) Appl. No.: 12/736,057

(22) PCT Filed: Mar. 4, 2008
(86) PCT No.: PCT/JP2008/053837

§ 371 Date: Sep. 3, 2010

(51) Int. Cl. G03B 21/28; F21V 11/00; F21V 5/00; G03B 21/14

(52) U.S. Cl. 353/81; 362/317; 362/326; 362/328

(57) ABSTRACT

The illumination optical system of the present invention guides a luminous flux from light source 11 to display element 20 modulating the luminous flux irradiating display surface 20a according to an image signal, and causes the luminous flux to be incident on display surface 20a at an inclination with respect to the surface normals of display surface 20a. This illumination optical system includes: light tunnel 12 uniformizing an illuminance distribution of the luminous flux incident from light source 11 and emitting the beam; first lens 13 for forming an image of output end 12b of light tunnel 12 on display surface 20a of display element 20; and prism element 19 that is arranged on the optical path between emitting surface 12b of light tunnel 12 and first lens 13 and where incident surface 19a and emitting surface 19b for the luminous flux from light tunnel 12 are formed so as to be planes nonparallel to each other. The thicknesses of prism element 19 at the rim of incident surface 19a in a direction parallel to the optical axis of light tunnel 12 are asymmetrical around the rim with respect to the optical axis of prism element 19.

### TECHNICAL FIELD

The present invention relates to an illumination optical system that guides a luminous flux from a light source to a display element modulating the irradiated luminous flux according to an image signal, and a projection display apparatus for projecting an image on a projection plane such as a screen.

### BACKGROUND ART

FIG. 1 shows an illumination optical system of a projection display apparatus related to the present invention. The illumination optical system employs a reflective display element, and includes light tunnel 112 that uniformizes a nonuniform luminous flux from light source 111 in order to decrease inconsistencies in the brightness of an image projected on a screen by a reflective display element. The end face of the output end of light tunnel 112 has a rectangular shape; optical elements 113, 114, 116 and 117 arranged between light tunnel 112 and display element 120 form an image thereof on the reflective display element.

This configuration employs a typical DMD (Digital Micromirror Device) as a reflective display element. This configuration requires that illumination light from the output end of light tunnel 112 is incident from obliquely below or obliquely above with respect to the surface normals of the display surface of display element (DMD) 120. Accordingly, such illumination light is incapable of forming a rectangular image of the output end of light tunnel 112 on the display surface of display element 120; the image is distorted in a trapezoidal shape. This causes a problem in which the illuminance distribution on the display surface of display element 120 is nonuniform.

FIG. 2 shows an irradiation state where the display surface of display element 120 is irradiated in the configuration related to the present invention shown in FIG. 1 by means of an illuminance distribution using contour lines. As shown in FIG. 2, the image of the output end of light tunnel 112 cannot be formed on the display surface of display element 120 in a rectangular shape; the image becomes a trapezoidally distorted shape. This requires that entire display area S11, which is a display surface configured by a reflective mirror group of display element 120, be disposed within trapezoidally distorted irradiation area S12. Irradiation area S12 on the display surface of display element 120 is therefore supposed to be ensured larger than the entire display surface of display element 120. As a result, this causes inconvenience in which the luminous flux of light, that is irradiated on the outside of display area S11 of display element 120, becomes unuseful.

FIG. 3 shows illuminances on the display surface of display element 120 along a direction parallel to section A-A′ of the display surface of display element 120 in FIG. 2. In FIG. 3, the axis of abscissas represents A-A′ direction, or positions in the direction of a long side of the display surface; the axis of ordinates represents illuminances. As shown in FIG. 3, the position with the highest illuminance in the display surface of display element 120 is disposed to be shifted to A′ side with respect to the center position of the display surface of display element 120. The illuminances on A′ side are higher than those on A side, and are in a nonuniform state.

### DISCLOSURE OF THE INVENTION

A configuration (JP2004-45718A) is disclosed as a related art to solve these problems. The configuration performs correction of trapezoidal distortion (keystone correction) by including a decentered optical system, where the optical axis of a lens arranged in the optical path of a luminous flux emitted from a light tunnel is shifted parallel to the optical axis of the light tunnel or turned about at least any one of three axes, thereby being inclined with respect to the optical axis of the light tunnel. FIG. 4 shows an example of an illumination optical system employing the art disclosed in this patent gazette. However, according to this configuration, the shift and turn of optical axes 123a and 124a of lens 123 and 124 with respect to optical axis 112c of light tunnel 112 enlarges the sizes of components of the illumination optical system. This causes a problem in which the shape of mechanical elements for holding lenses 123 and 124 of the illumination optical system becomes complicated because of the shifting and turning of the optical axes of lenses 123 and 124 of the illumination optical system, thereby increasing the size, weight and manufacturing cost of the apparatus.

It is an object of the present invention to provide an illumination optical system and a projection display apparatus that allow the illuminance distribution on the display surface of a display element to be uniformized and also enable the entire illumination optical system to be downsized and reduced in weight.

In order to achieve the above-mentioned object, an illumination optical system pertaining to the present invention is an illumination optical system that guides a luminous flux from a light source to a display element modulating the luminous flux irradiating a display surface according to an image signal and causes the luminous flux to be incident on the display surface at an inclination with respect to the surface normals of the display surface, including:

a light tunnel uniformizing an illuminance distribution of the luminous flux incident from the light source and emitting the beam;

an optical element for forming an image of an emitting surface of the light tunnel on the display surface of the display element; and

a prism element that is arranged on an optical path between the emitting surface of the light tunnel and the optical element and where an incident and emitting surfaces for the luminous flux from the light tunnel are formed so as to be planes that are nonparallel to each other. The thickness of the prism element at a rim of the incident surface in a direction parallel to the optical axis of the light tunnel is asymmetrical around the rim with respect to the optical axis of the prism element.

Further, the projection display apparatus pertaining to the present invention includes: the illumination optical system pertaining to the present invention; the display element; and an imaging optical system for enlarging and projecting the luminous flux modulated by the display element.

According to the present invention including the above-described configuration, in an illumination optical system where the emitting surface of the light tunnel as the output end is an object plane and where the display surface of the display element is an imaging plane, the prism element that makes the optical distance between the output end of the light tunnel, as the object plane, and the optical element, asymmetrical with respect to the optical axis of the light tunnel, is disposed. This improves the image-forming feature on the display surface of the display element, and makes the shape of an irradiation area in the display surface similar to a substantially rectangular shape.

In this exemplary embodiment, for example, the prism element formed such that the incident and emitting surfaces for the luminous flux from the light tunnel are nonparallel to each other is disposed in the vicinity of the output end of the light tunnel. This allows the optical distance (optical path length) between the output end of the light tunnel and the optical elements to be asymmetrical with respect to the optical axis.

As shown in FIG. 5, in an optical system that forms an image of object plane 101 equivalent to the emitting surface of the light tunnel on imaging plane 105 using optical elements such as lenses 102, 103 and 104, prism element 106 such as glass is inserted into the optical path between object plane 101 and lens 102. This allows the position of imaging plane 105 to be changed so that it is further away from an original position. This principle is applied to the present invention.

### Advantages of the Invention

According to the present invention, the distortion of the shape of the irradiation area irradiated on the display surface of the display element is suppressed, and the shape is made similar to the substantially rectangular shape. Accordingly, the unavailable amount of the luminous flux owing to irradiation on the outside of the display surface can be decreased, thereby allowing the brightness of the display surface to be increased. At the same time, the nonuniformity of the illuminance distribution on the display surface can be alleviated. Further, the present invention enables the diameter of the lens included in the optical element to be decreased. This in turn allows the entire illumination optical system to be downsized and allows the weight to be reduced.

### BRIEF DESCRIPTION OF THE DRAWINGS

FIG. 1 is a perspective view showing an illumination optical system of a projection display apparatus related to the present invention;

FIG. 2 is a front view showing a display area and an irradiation area on the display surface of a display element;

FIG. 3 is a diagram showing an illuminance distribution along A-A′ direction in FIG. 2;

FIG. 4 is a perspective view showing an illumination optical system of another projection display apparatus related to the present invention;

FIG. 5 is a diagram for illustrating a principle of the present invention;

FIG. 6A is a perspective view showing an illumination optical system of a projection display apparatus of a first exemplary embodiment;

FIG. 6B is a perspective view showing a shape of a prism element employed in the optical system;

FIG. 6C is a front view showing the display surface of a display element employed in the optical system;

FIG. 7 is a front view showing a display area and an irradiation area on the display surface of the display element;

FIG. 8 is a diagram showing an illuminance distribution along B-B′ direction in FIG. 7;

FIG. 9A is a perspective view showing an illumination optical system of a projection display apparatus of a second exemplary embodiment; and

FIG. 9B is a perspective view showing the shape of a prism element employed in the optical system.

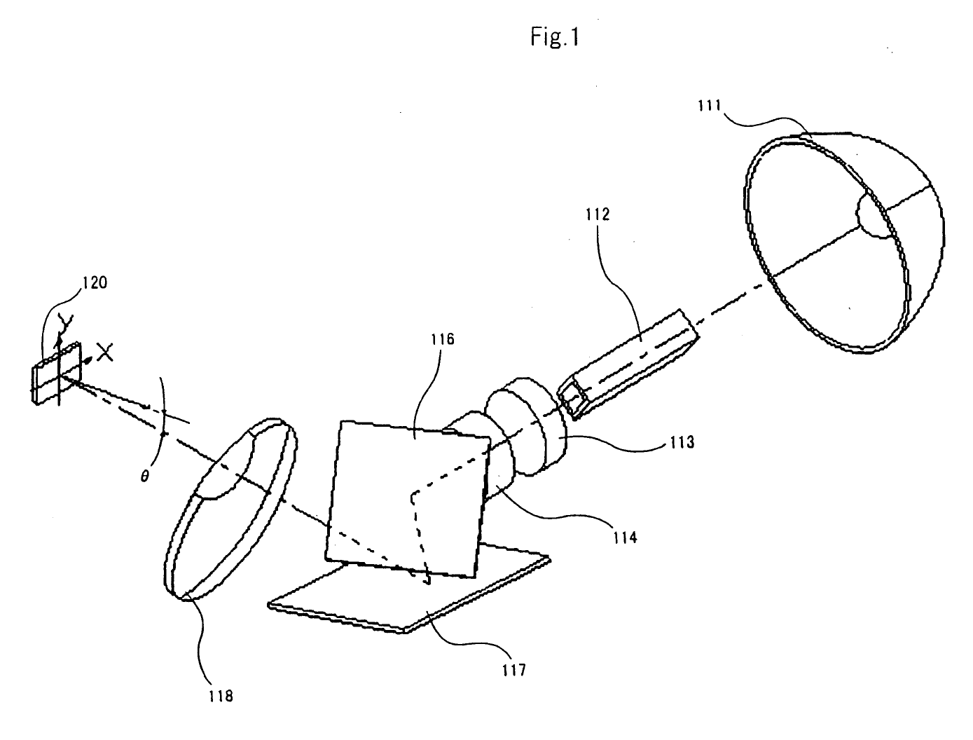

### BEST MODE FOR CARRYING OUT THE INVENTION

A specific exemplary embodiment will hereinafter be described with reference to the drawings.

### First Exemplary Embodiment

A projection display apparatus of a first exemplary embodiment includes a display element that modulates a luminous flux irradiating a display surface according to an image signal, an illumination optical system that guides a luminous flux from a light source to the display element such that the beam enters a display surface, and an imaging optical system that enlarges and projects the luminous flux modulated by the display element.

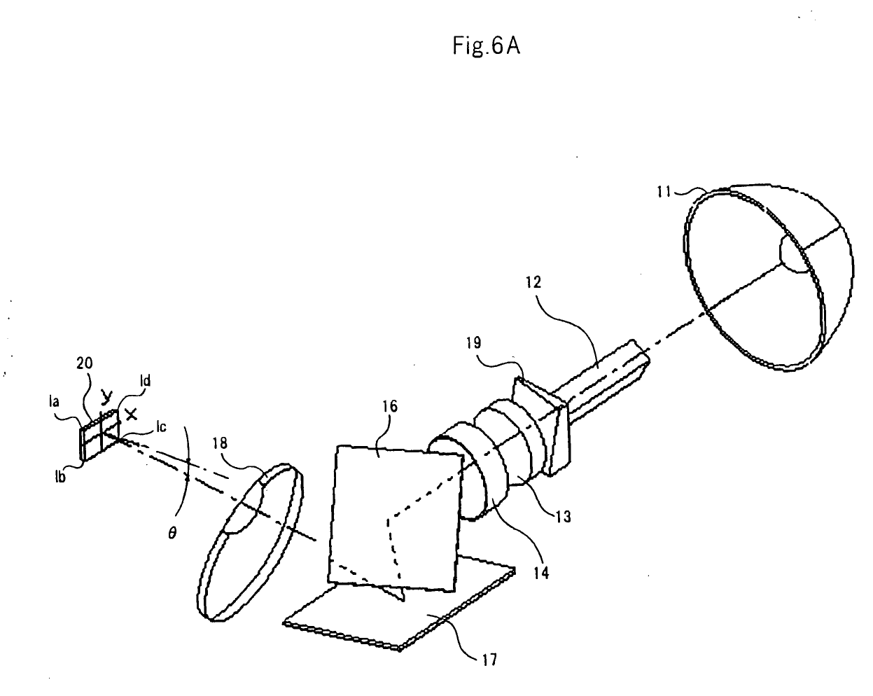

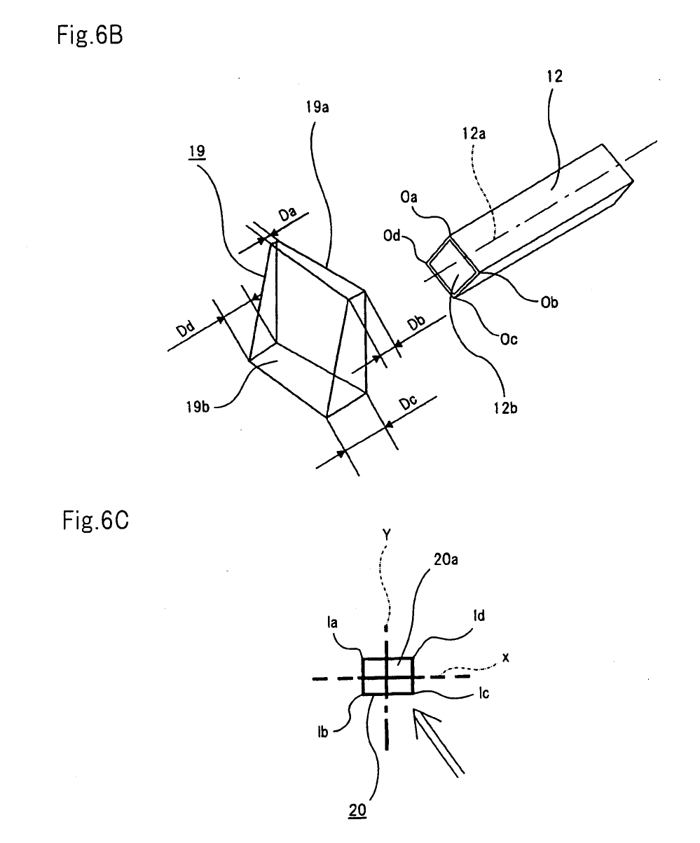

FIG. 6A shows the illumination optical system included in the projection display apparatus of the first exemplary embodiment. FIG. 6B is a perspective view showing the shape of a prism element.

As shown in FIG. 6A, the illumination optical system of this exemplary embodiment includes, sequentially on the optical path: light source 11 emitting illumination light; light tunnel 12 that uniformizes the illuminance distribution of the luminous flux incident from the light source and emits the uniformized beam; and optical elements for forming an image of output end 12b of light tunnel 12 on display surface 20a of display element 20, including first and second lenses 13 and 14, first and second reflective mirrors 16 and 17, and third lens 18. As shown in FIGS. 6A and 6B, the illumination optical system further includes prism element 19 that is disposed on the optical path between output end 12b of light tunnel 12 and first lens 13 and formed such that incident surface 19a and emitting surface 19b for the luminous flux from light tunnel 12 are nonparallel to each other.

The illumination optical system is configured such that the luminous flux from light source 11 is incident on display surface 20a at a prescribed inclination θ with respect to the surface normals of display surface 20a of display element 20.

A DMD, which is a reflective display element, is employed as display element 20 included in the projection display apparatus of this exemplary embodiment. The DMD includes rectangular display surface 20a.

Light tunnel 12 is formed as a hollow quadrangular column; the end face is rectangularly formed such that irradiation area S2 irradiated on rectangular display surface 20a of display element 20 becomes rectangular. Light tunnel 12 includes a light guide path surrounded by reflectors, an input end provided at one end of this light guide path, and output end 12b, which is an emitting surface provided at the other end of the light guide path. Light tunnel 12 uniformizes the illuminance distribution of the luminous flux entering the input end and subsequently emits the uniformized beam from output end 12b. Note that uniformization of the illuminance distribution by light tunnel 12 is not limited to uniformization of the illuminance distribution of the luminous flux into a substantially uniform state. Instead, this uniformization includes an effect of decreasing nonuniformity of the illuminance distribution.

Output end 12b of light tunnel 12 and display surface 20a of display element 20 have a relationship as with an object plane and an imaging plane in the illumination optical system. As shown in FIGS. 6B and 6C, images of four corners Oa, Ob, Oc and Od of output end 12b of light tunnel 12 are formed corresponding to four corners Ia, Ib, Ic and Id of display area S1 of display element 20, respectively. In FIG. 6C, an arrow indicates the incident direction of the illumination light. More specifically, this exemplary embodiment is configured such that the illumination light is incident on display surface 20a of display element 20 from a direction near corner Ic of display surface 20a of display element 20 at inclination θ with respect to the surface normals of display surface 20a of display element 20.

The optical axes of first and second lenses 13 and 14 are arranged so as to coincide with the optical axis of light tunnel 12. First and second reflective mirrors 16 and 17 are arranged so as to bend the optical axis of the illumination light from second lens 14 to display element 20. The optical axis of third lens 18 coincides with the optical axis of the illumination light from second reflective mirror 17. The optical axis of the illumination light from third lens 18 is incident on display surface 20a at an inclination from obliquely below in directions of the X and Y axes with respect to the surface normals of display surface 20a of display element 20, or is incident in an inclined state into the so-called fourth quadrant of display surface 20a. The illumination light reflected by display element 20 is projected on a projection plane such as, for example, a screen by a projection lens included in an imaging optical system, which is not shown.

Prism element 19 is formed such that incident surface 19a is parallel to output end 12b of light tunnel 12, or such that incident surface 19a is perpendicular to the optical axis of light tunnel 12. On the other hand, emitting surface 19b of prism element 19 is formed so as to be inclined with respect to output end 12b of light tunnel 12, or such that emitting surface 19b is inclined with respect to a plane perpendicular to the optical axis of light tunnel 12. That is, incident surface 19a and emitting surface 19b are nonparallel to each other. Accordingly, in a case without prism element 19, the optical distance from output end 12b of light tunnel 12 to corner Ic of display surface 20a of display element 20 is the shortest; the optical distance from output end 12b of light tunnel 12 to corner Ia of display surface 20a is the longest.

As shown in FIG. 6B, prism element 19 is configured such that the thickness in a direction parallel to the optical axis of light tunnel 12 around the rim of incident surface 19a is asymmetrical around the rim with respect to the optical axis of prism element 19. In other words, prism element 19 has different thicknesses at the four corners of incident surface 19a.

More specifically, as to the inclined state of emitting surface 19b of prism element 19, the thicknesses Da, Db, Dc and Dd at four corners of the prism element disposed in the vicinity of the respective four corners Oa, Ob, Oc and Od of output end 12b of light tunnel 12 are configured such that the thickness Dc of the corner, which is in the vicinity of corner Oc corresponding to corner Ic nearest to the optical axis incident on display surface 20a among four corners Ia, Ib, Ic and Id of display surface 20a of display element 20, is the largest. Further, prism element 19 is formed such that thickness Da at the corner, which is in the vicinity of corner Oa corresponding to corner Ia farthest from corner Ic of display surface 20a of display element 20, is the smallest.

Prism element 19 according to this exemplary embodiment is formed such that the thicknesses at the four corners of incident surface 19a satisfy Dc>Dd>Db>Da.

According to the above-described configuration related to the present invention, the distance between the output end (object plane) of the light tunnel and the lens, which is arranged between the output end and the display surface (imaging plane) of the display element, is symmetrical with respect to the central axis (optical axis) of the output end of the light tunnel. On the other hand, according to this exemplary embodiment, prism element 19, which is configured such that the thicknesses of the four corners at the rim of incident surface 19a are asymmetrical (having different thicknesses) with respect to the optical axis of prism element 19, is inserted between output end 12b of light tunnel 12 and first lens 13. Prism element 19 causes the optical lengths with respect to the optical axis (central axis of output end 12b) of light tunnel 12 to be asymmetrical. Accordingly, correction is made such that the optical path lengths become identical to each other, on display surface 20a of display element 20 where display surface 20a is inclined at the prescribed inclination θ with respect to the optical axis of the illumination light, thereby acquiring a fine image-forming feature. That is, the shape of irradiation area S2 irradiated on display surface 20a can be made similar to a substantially rectangular shape.

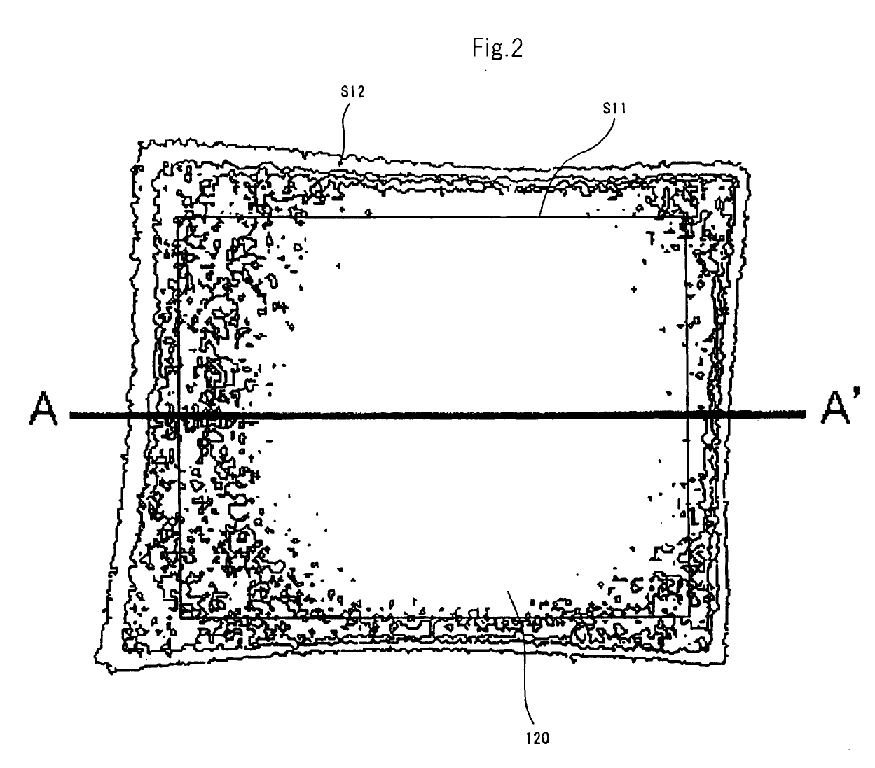

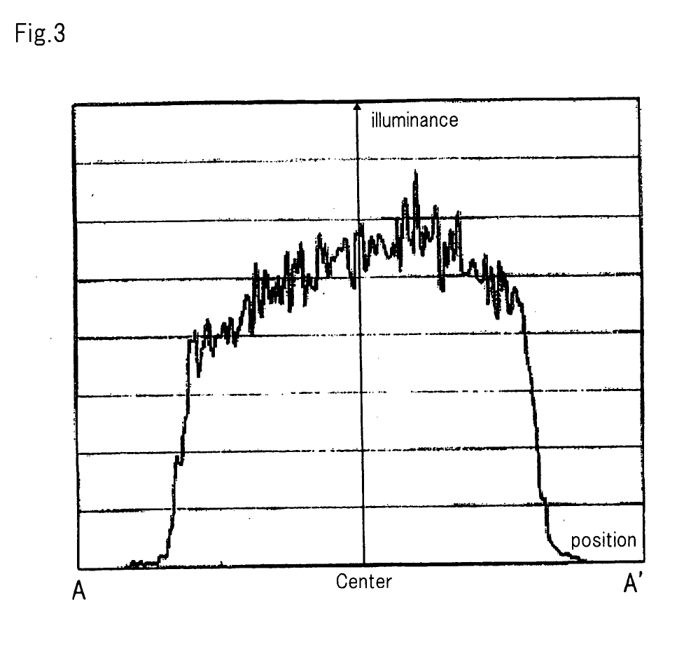

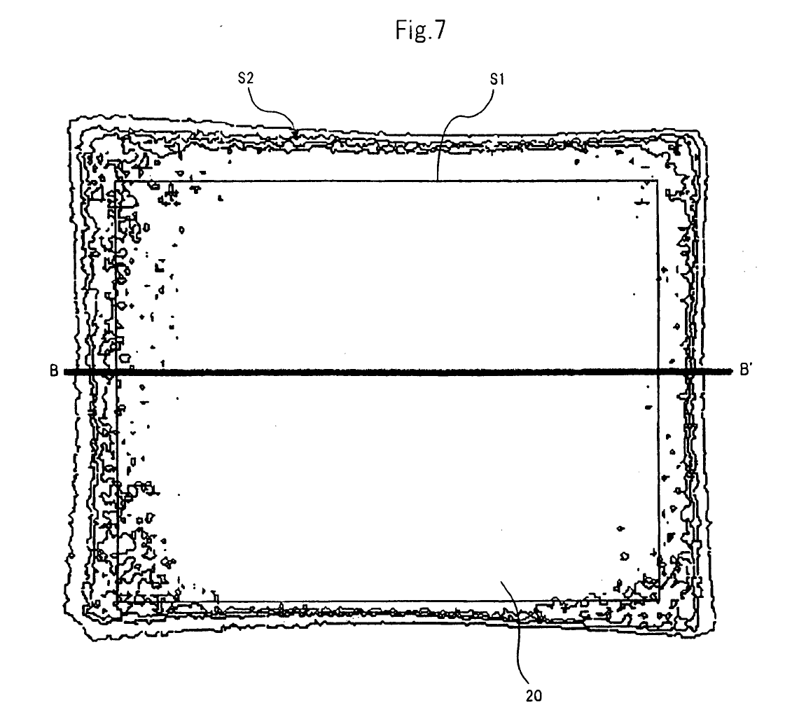

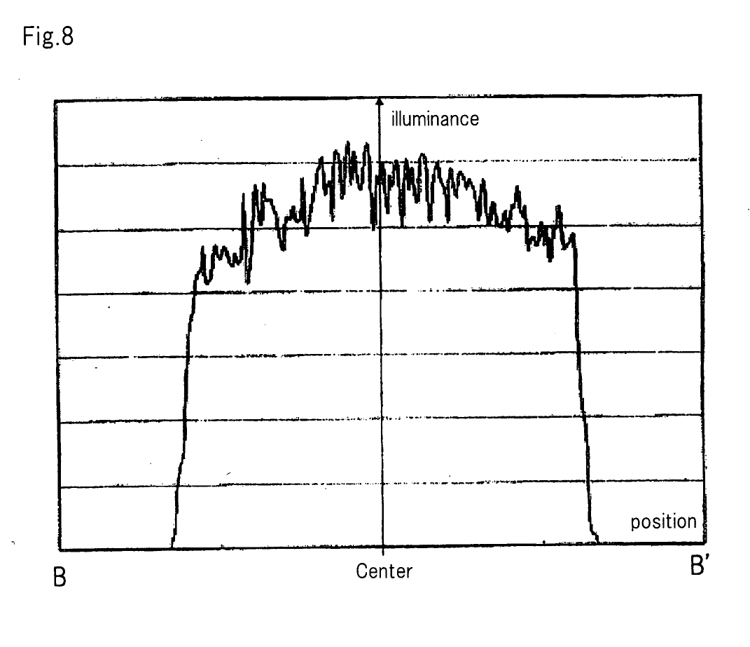

FIG. 7 shows an irradiation state where irradiation is made on display surface 20a of display element 20 in the exemplary embodiment by means of contour lines of illuminance distribution. Here, the distortion of the shape of irradiation area S2 is alleviated; this allows the unavailable amount of light owing to irradiation on the outside of display area S1 of display element 20 to be decreased by about 6%, in comparison with the illuminance distribution (FIG. 2) of the example of the configuration related to the present invention. FIG. 8 shows illumination values along section B-B′ of display surface 20a shown in FIG. 7. In FIG. 8, the axis of abscissas represents B-B′ direction, i.e., positions in a long side direction of the display surface; the axis of ordinates represents illuminances. The position of the illuminance at the peak is disposed substantially at the center of display surface 20a. The symmetry of illuminance distribution with respect to the center in B-B′ direction and uniformity of the illuminance distribution in B-B′ direction can be increased.

As described above, according to this exemplary embodiment, the distortion of the shape of irradiation area S2 irradiated on display surface 20a of display element 20 is suppressed, and the shape is made similar to the substantially rectangular shape. Accordingly, the unavailable amount of the luminous flux owing to irradiation on the outside of display surface 20a can be decreased, thereby allowing the brightness of the display surface to be increased; at the same time, the nonuniformity of the illuminance distribution on display surface 20a can be alleviated.

Further, according to this exemplary embodiment, the nonuniformity of illuminance distribution on display surface 20a can be alleviated, without arranging (turning) the optical axis of the lens to be inclined with respect to the optical axis of the light tunnel by arranging (shifting) the optical axis of the lens in a displaced manner parallel to the optical axis of the light tunnel or turning the optical axis in at least any one direction of three axes, as with the illumination optical system related to the present invention. That is, according to this exemplary embodiment, the amount of shift and the amount of turn of the optical axes of first and second lenses 13 and 14 can be zero. This enables the diameters of first and second lenses 13 and 14 to be decreased more than those of the illumination optical system related to the present invention. The entire illumination optical system including the mechanism for holding first and second lenses 13 and 14 can be downsized and reduced in weight, thereby allowing downsizing of the projection display apparatus to be realized.

### Second Exemplary Embodiment

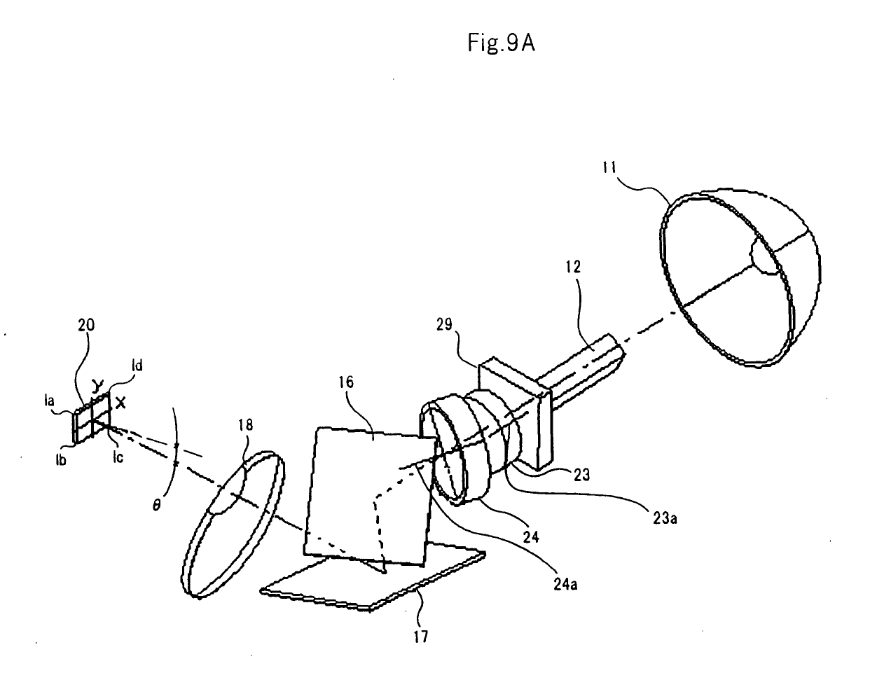

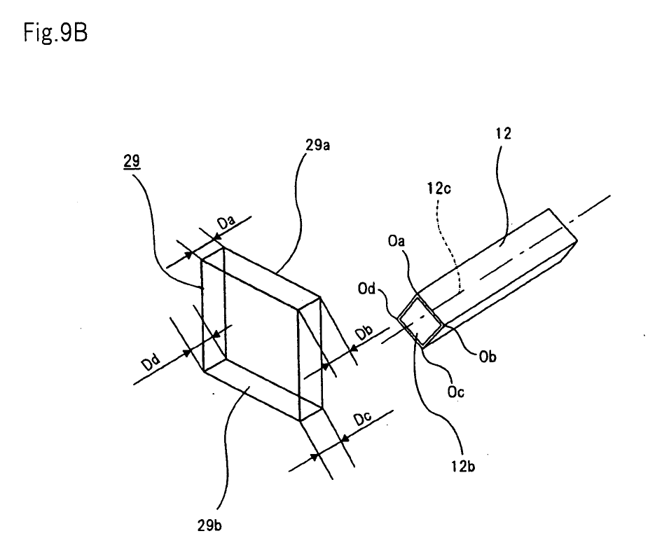

FIG. 9A shows an illumination optical system included in a projection display apparatus of a second exemplary embodiment. In this exemplary embodiment, for the sake of the convenience, identical components to the components of the first exemplary embodiment are assigned with the identical symbols, and the description thereof will be omitted.

This exemplary embodiment is different from the first exemplary embodiment in that the optical axes of the first and second lenses of the first exemplary embodiment are shifted or turned with respect to the optical axis of the light tunnel.

As shown in FIG. 9A, optical axis 23a of first lens 23 are arranged so as to be displaced parallel to optical axis 12c of light tunnel 12. Further, optical axis 24a of second lens 24 is arranged so as to be inclined with respect to optical axis 12c of light tunnel 12 by turning in at least any one of the three axes.

Also in this exemplary embodiment, as with the first exemplary embodiment, prism element 29 is arranged between output end 12b of light tunnel 12 and first lens 23. Prism element 29 is formed in a shape where incident surface 29a is parallel to output end 12b of light tunnel 12 and emitting surface 29b of the prism element is inclined with respect to output end 12b of light tunnel 12.

In this exemplary embodiment, a corrective process to cause the shape of irradiation area S2 on display surface 20a of display element 20 to become rectangular is executed on first and second lenses 23 and 24 and prism element 29. In the illumination optical system of this exemplary embodiment, the point, at which a corrective process to cause irradiation area S2 to become rectangular by shifting and turning the optical axes of first and second lenses 23 and 24 is excessively executed, can be deformed so that it takes on an inverse shape instead or can become trapezoidally deformed, by prism element 29. Accordingly, it is not necessary that the inclined state of emitting surface 29b of prism element 29 be formed as with the inclined state of emitting surface 19b in the first exemplary embodiment.

As shown in FIG. 9B, prism element 29 in this exemplary embodiment is formed such that thicknesses Da, Db, Dc and Dd of the four corners of prism element 29 disposed in the vicinity of respective four corners Oa, Ob, Oc and Od of output end 12b of light tunnel 12 satisfy Dd>Dc>Da>Db.

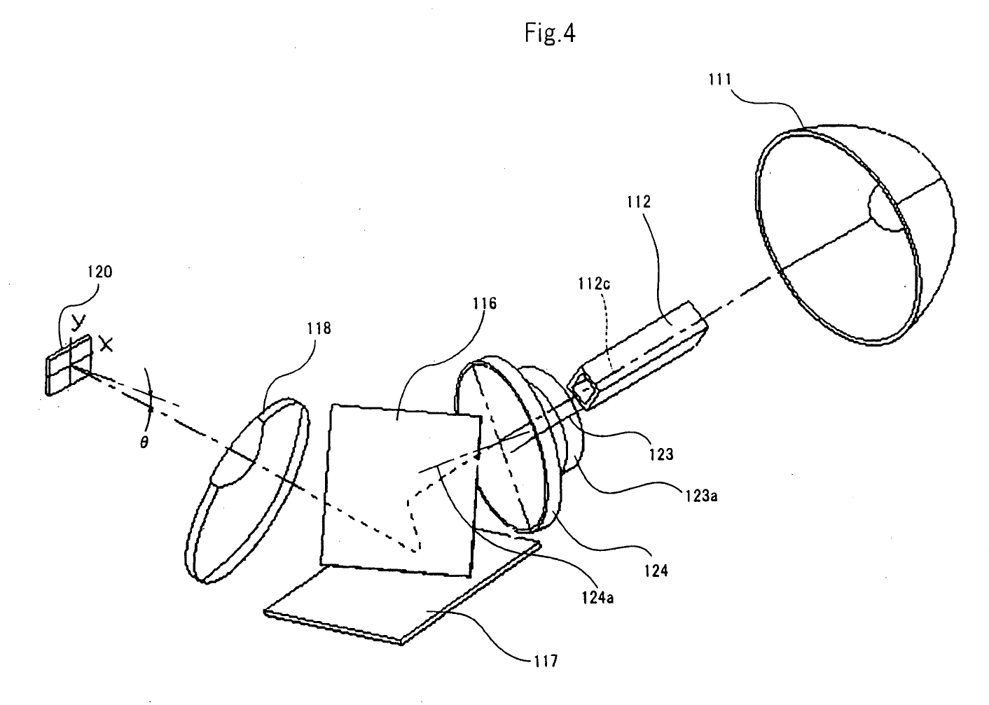

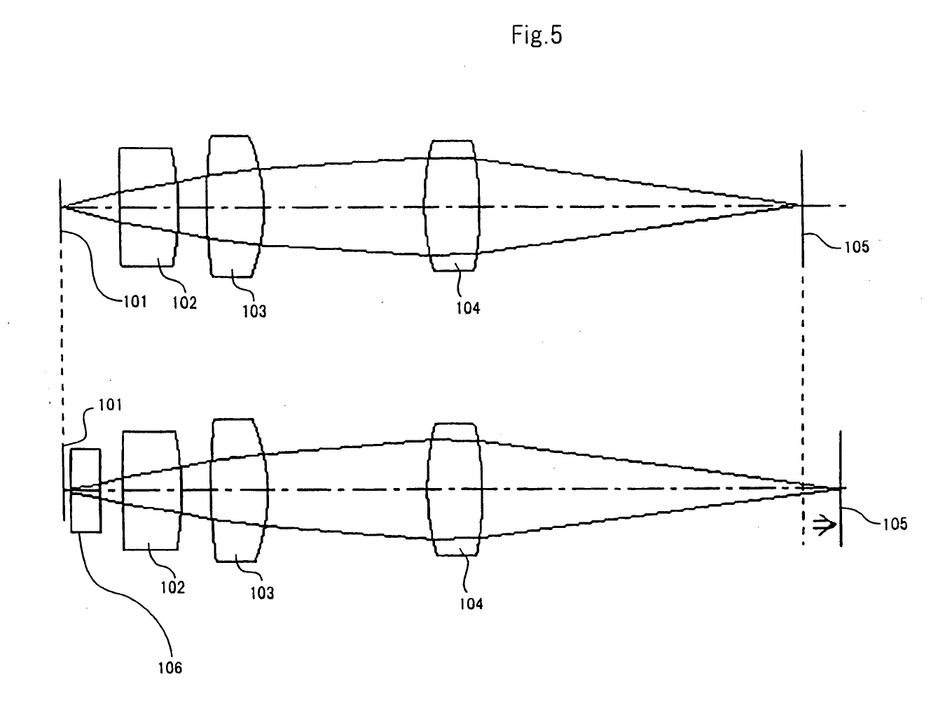

According to this exemplary embodiment, in comparison with the illumination optical system (FIG. 4) related to the present invention, which is configured by shifting and turning the optical axis of the lens of the illumination optical system, the amount of light unavailable at the outside of display area S1 of display element 20 is suppressed substantially identically thereto, and prism element 29 is employed, thereby allowing the amount of shift and amount of turn of first and second lenses 23 and 24 of the illumination optical system to be reduced. This enables the diameters of first and second lenses 23 and 24 to be reduced.

Therefore, in this exemplary embodiment, provided that the numerical aperture of output end 12b of light tunnel 12 is NA=0.35, in a case of forming the image of output end 12b on display surface 20a of display element 20 at two-fold magnification, the diameter of first lens 23 can be decreased by 10% and the weight of first lens 23 can be decreased by 8%, while the diameter of second lens 24 can be reduced by 30% and the weight of second lens 24 can be decreased by 30%, in comparison with the related illumination optical system.

Therefore, according to the second exemplary embodiment, the entire illumination optical system including the mechanism (not shown) for holding first and second lenses 23 and 24 can be downsized and reduced in weight, thereby allowing downsizing of the entire projection display apparatus to be realized.

Note that the light tunnel is not limited to an object that is in the shape of a hollow quadrangular column. A prismatic lens, or so-called a rod lens, can be employed instead. The light tunnel according to the present invention indicates an optical element including such a rod lens.

As described above, the invention of the application has been described with reference to the exemplary embodiments. However, the invention of the application is not limited to the exemplary embodiments. Various modifications, which can be understood by those skilled in the art, may be made to the configuration and details of the invention of the application within the scope of the invention of the application.

1. An illumination optical system that guides a luminous flux from a light source to a display element modulating the luminous flux irradiating a display surface according to an image signal and that causes the luminous flux to be incident on the display surface at an inclination with respect to the surface normals of the display surface, comprising:
a light tunnel uniformizing an illuminance distribution of the luminous flux incident from the light source and emitting the beam;
an optical element for forming an image of an emitting surface of the light tunnel on the display surface of the display element; and
a prism element that is arranged on an optical path between the emitting surface of the light tunnel and the optical element and where an incident and emitting surface for the luminous flux from the light tunnel are formed so as to be planes nonparallel to each other,
wherein thickness of the prism element at a rim of the incident surface in a direction parallel to the optical axis of the light tunnel is asymmetrical around the rim with respect to the optical axis of the prism element.

2. The illumination optical system according to claim 1, wherein the prism element is formed such that the incident surface has a rectangular shape parallel to the emitting surface of the light tunnel and the thicknesses at corners of the incident surface are different from each other.

3. The illumination optical system according to claim 1, wherein the optical element includes lenses and is arranged such that the optical axis of at least one of the lenses coincides with the optical axis of the light tunnel.

4. The illumination optical system according to claim 1, wherein the optical element includes lenses and is arranged such that the optical axis of at least one of the lenses is displaced parallel to the optical axis of the light tunnel or is arranged at an inclination with respect to the optical axis of the light tunnel.

5. The illumination optical system according to claim 1, wherein the optical element includes lenses and at least one reflective mirror and is arranged such that the optical axis of at least one of the lenses coincides with the optical axis of the light tunnel.

6. The illumination optical system according to claim 1, wherein the optical element includes lenses and at least one reflective mirror and is arranged such that the optical axis of at least one of the lenses is displaced parallel to the optical axis of the light tunnel or is arranged at an inclination with respect to the optical axis of the light tunnel.

7. A projection display apparatus, comprising: the illumination optical system according to claim 1; the display element; and an imaging optical system for enlarging and projecting the luminous flux modulated by the display element.

8. A projection display apparatus, comprising: the illumination optical system according to claim 2; the display element; and an imaging optical system for enlarging and projecting the luminous flux modulated by the display element.

9. A projection display apparatus, comprising: the illumination optical system according to claim 3; the display element; and an imaging optical system for enlarging and projecting the luminous flux modulated by the display element.

10. A projection display apparatus, comprising: the illumination optical system according to claim 4; the display element; and an imaging optical system for enlarging and projecting the luminous flux modulated by the display element.

11. A projection display apparatus, comprising: the illumination optical system according to claim 5; the display element; and an imaging optical system for enlarging and projecting the luminous flux modulated by the display element.

12. A projection display apparatus, comprising: the illumination optical system according to claim 6; the display element; and an imaging optical system for enlarging and projecting the luminous flux modulated by the display element.
